(19) United States
(12) Patent Application Publication
(10) Pub. No.: US 2026/0329372 A1
(43) Pub. Date: Oct. 22, 2026

(54) INFORMATION PROCESSING APPARATUS, CONTROL METHOD OF INFORMATION PROCESSING APPARATUS, AND NON-TRANSITORY COMPUTER-READABLE STORAGE MEDIUM

(71) Applicant: NEC Corporation, Tokyo (JP)

(72) Inventors: Masatoshi Furukawa, Tokyo (JP); Yusuke Mori, Tokyo (JP); Akio Yoshioka, Tokyo (JP); Yu Tsumuraya, Tokyo (JP); Sayo Minowa, Tokyo (JP)

(73) Assignee: NEC Corporation, Tokyo (JP)

(21) Appl. No.: 19/468,206

(22) Filed: Feb. 3, 2026

(30) Foreign Application Priority Data
Mar. 1, 2025 (JP) 2025-032493

(51) Int. Cl. G06F 3/01; G06T 7/50; G06T 11/00; G06V 10/25; G06V 20/20; G06V 40/20

(52) U.S. Cl. CPC G06F 3/013; G06F 3/017; G06T 7/50; G06T 11/00; G06V 10/25; G06V 20/20; G06V 40/28; G06T 2207/30196

(57) ABSTRACT

An information processing apparatus includes a recognition means, an acquisition means, a detection means, and a display means. The recognition means recognizes a predetermined terminal. The acquisition means acquires content data corresponding to content displayed on a screen of the predetermined terminal. The detection means detects that a user has performed a first operation on a region in which the predetermined terminal appears in a real-space image obtained by capturing a real space. The display means displays, superimposed on the real-space image, the content corresponding to the acquired content data in response to the first operation being detected.

### INCORPORATION BY REFERENCE

This application is based upon and claims the benefit of priority from Japanese Patent Application No. 2025-032493, filed on Mar. 1, 2025, the disclosure of which is incorporated herein in its entirety by reference.

### TECHNICAL FIELD

The present disclosure relates to an information processing apparatus, a control method of an information processing apparatus, and a non-transitory computer-readable storage medium.

### BACKGROUND ART

There is technology related to screen sharing between an HMD (Head Mounted Display) and a smartphone and the like.

For example, Patent Literature 1 (WO2022/269753) describes that a screen such as a screen of an app selected on an information processing apparatus such as a smartphone can be displayed simply and with good usability at a suitable display position and a suitable display size on a display screen of an image display apparatus such as an HMD.

The information processing system of Patent Literature 1 includes an HMD equipped with a camera, and a smartphone that operates and displays an app which is application software.

The information processing system includes a communication linkage function of information between the HMD and the smartphone. In addition, the HMD captures and reads the screen of the smartphone by a camera, and recognizes a display position and a display size of the read screen of the smartphone as a display area. The HMD displays an image of the screen of the smartphone in the recognized display area.

As disclosed in Patent Literature 1, screen sharing and content sharing are performed between a wearable device, smart glasses, a head-mounted display and the like, and a smartphone and the like. In Patent Literature 1, among regions of a screen of an HMD, a region in which a smartphone appears is set as a display area of content. In the information processing system of Patent Literature 1, there is a problem that a user cannot view a screen of a smartphone on an HMD at a preferred position. A user of the HMD disclosed in Patent Literature 1 may feel poor usability because the user cannot freely change a screen position of the smartphone.

### SUMMARY

It is a main object of the present disclosure to provide an information processing apparatus, a control method of an information processing apparatus, and a non-transitory computer-readable storage medium that contribute to improving convenience for a user who desires screen sharing and content sharing with a terminal such as a smartphone.

According to a first aspect of the present disclosure, there is provided an information processing apparatus including: a recognition means that recognizes a predetermined terminal; a acquisition means that acquires content data corresponding to content displayed on a screen of the predetermined terminal; a detection means that detects that a user has performed a first operation on a region in which the predetermined terminal appears in a real-space image obtained by capturing a real space; and a display means that displays, superimposed on the real-space image, the content corresponding to the acquired content data in response to the first operation being detected.

According to a second aspect of the present disclosure, there is provided a control method of an information processing apparatus, the control method including: a recognition step that recognizes a predetermined terminal; a acquisition step that acquires content data corresponding to content displayed on a screen of the predetermined terminal; a detection step that detects that a user has performed a first operation on a region in which the predetermined terminal appears in a real-space image obtained by capturing a real space; and a display step that displays, superimposed on the real-space image, the content corresponding to the acquired content data in response to the first operation being detected.

According to a third aspect of the present disclosure, there is provided a non-transitory computer-readable storage medium storing a program causing a computer mounted on an information processing apparatus to perform processing for: a recognition processing that recognizes a predetermined terminal; a acquisition processing that acquires content data corresponding to content displayed on a screen of the predetermined terminal; a detection processing that detects that a user has performed a first operation on a region in which the predetermined terminal appears in a real-space image obtained by capturing a real space; and a display processing that displays, superimposed on the real-space image, the content corresponding to the acquired content data in response to the first operation being detected.

### BRIEF DESCRIPTION OF THE DRAWINGS

Exemplary features and advantages of the present disclosure will become apparent from the following detailed description when taken with the accompanying drawings in which:

FIG. 1 is a diagram for illustrating an outline of an example embodiment;

FIG. 2 is a flowchart illustrating operation of an example embodiment;

FIG. 3 is a diagram for explaining utilization of an HMD according to an example embodiment of the present disclosure;

FIG. 4 is a diagram illustrating an example of a screen display of the HMD according to the example embodiment of the present disclosure;

FIG. 5 is a flowchart illustrating an example of an operation of the HMD according to the example embodiment of the present disclosure;

FIG. 6 is a diagram illustrating an example of a screen display of the HMD according to the example embodiment of the present disclosure;

FIG. 7 is a diagram illustrating an example of a screen display of the HMD according to the example embodiment of the present disclosure;

FIG. 8 is a diagram illustrating an example of a screen display of the HMD according to the example embodiment of the present disclosure;

FIG. 9 is a diagram illustrating an example of a screen display of the HMD according to the example embodiment of the present disclosure;

FIG. 10 is a diagram illustrating an example of a screen display of the HMD according to the example embodiment of the present disclosure;

FIG. 11 is a diagram illustrating an example of a processing configuration of the HMD according to the example embodiment of the present disclosure;

FIG. 12 is a diagram illustrating an example of a hardware configuration of the HMD according to the present disclosure; and

FIG. 13 is a diagram illustrating an example of a screen display of the HMD according to a variation of the present disclosure.

### EXAMPLE EMBODIMENT

First, an outline of an example embodiment will be described. It should be noted that in the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. It should be noted that in the present description and drawings, elements that can be described in a like way will be denoted by a like reference character, and redundant description thereof will be omitted as needed.

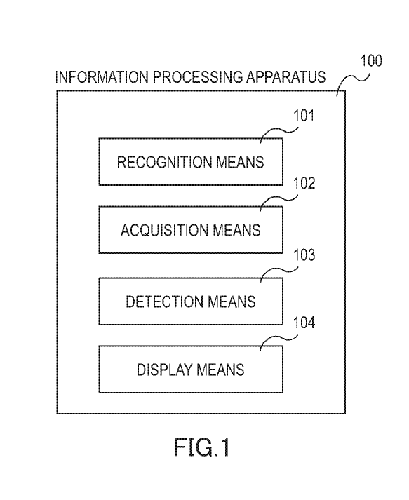

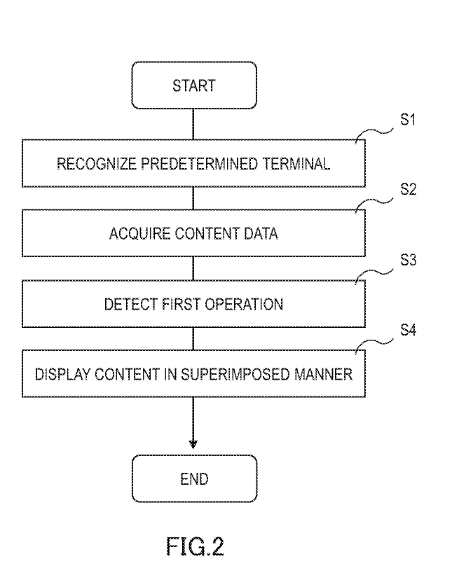

An information processing apparatus 100 according to an example embodiment includes a recognition means 101, an acquisition means 102, a detection means 103, and a display means 104 (see FIG. 1). The recognition means 101 recognizes a predetermined terminal (step S1 of FIG. 2). The acquisition means 102 acquires content data corresponding to content displayed on a screen of the predetermined terminal (step S2). The detection means 103 detects that a user has performed a first operation on a region in which the predetermined terminal appears in a real-space image obtained by capturing a real space (step S3). The display means 104 displays, superimposed on the real-space image, the content corresponding to the acquired content data in response to the first operation being detected (step S4).

The information processing apparatus 100 is, for example, the HMD (Head Mounted Display), and detects a user's operation on a terminal such as a smartphone that appears on a screen of the HMD by using the detection means 103. The information processing apparatus 100 displays, superimposed on the real-space image, the same content as content displayed on the smartphone or the like in response to the operation being detected. For example, in a case where a user pinches a screen of the smartphone and performs a releasing operation in the real-space image, the information processing apparatus 100 displays content displayed on the screen of the smartphone or the like at a location where the releasing operation is performed. As a result, convenience for a user who desires screen sharing and content sharing with a terminal such as a smartphone is improved.

Hereinafter, specific example embodiments will be described in more detail with reference to drawings.

### First Example Embodiment

A first example embodiment will be described in more detail with reference to drawings.

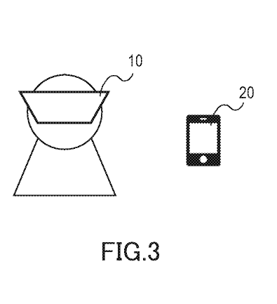

As illustrated in FIG. 3, a user wears a head-mounted display (HMD; Head Mounted Display) 10. In addition, the user uses a terminal 20 such as a smartphone, a tablet, and a personal computer and the like. In FIG. 3, a smartphone is illustrated as the terminal 20.

The user uses the HMD 10 and the terminal 20 together. For example, at home or at a workplace, the user operates the terminal 20 while wearing the HMD 10.

It should be noted that the user prepares the HMD 10 and the terminal 20 so as to be communicable with each other. For example, the user completes pairing between the HMD 10 and the terminal 20 by Bluetooth (registered trademark) in advance.

First, functions and the like of the HMD 10 will be outlined.

The HMD 10 is a virtual reality apparatus or an augmented reality apparatus that seamlessly realizes integration of a real world and virtual digital content. The HMD 10 is also a display apparatus for an augmented reality image. Goggles of the HMD 10 include a high-definition display and can superimpose and display three-dimensional digital content on the real world being visually recognized by the user.

The HMD 10 displays images on respective left and right displays inside goggles. The user can perform three-dimensional spatial recognition by using the respective left and right images. In addition, the HMD 10 includes a video camera installed so as to be capable of capturing a direction of visual recognition of the user, and adopts a video see-through method that displays digital content superimposed on an image captured in real time by the video camera.

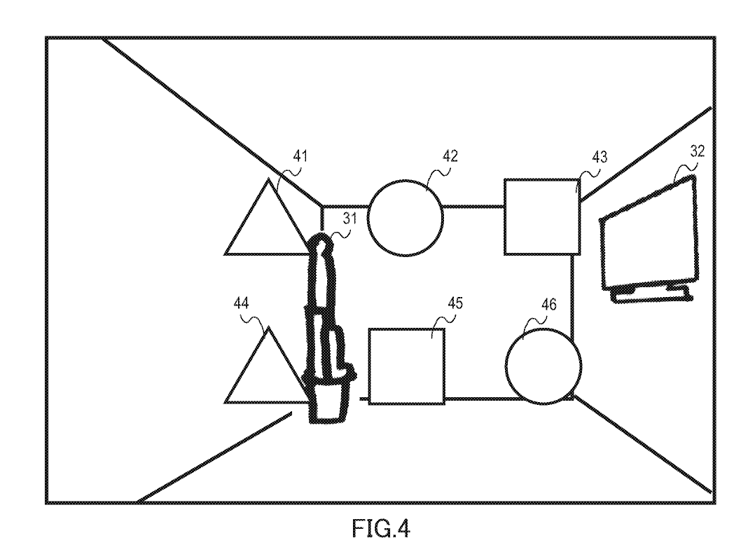

For example, in FIG. 4, a plant 31 and a television 32 are objects in a real world captured by the video camera. In contrast, icons 41 to 46 are digital content generated by the HMD 10.

It should be noted that, in the following description, an image (video) obtained by capturing a real world by the video camera of the HMD 10 and displayed on displays inside goggles is referred to as a "real-space image". For example, in the example of FIG. 4, an image in which icons 41 to 46 are not displayed corresponds to the real-space image.

In addition, an image corresponding to digital content generated by the HMD 10 such as icons 41 to 46 is referred to as an "augmented reality image". For example, a window for displaying information output by an application is also included in the augmented reality image.

An OS (Operating System) is installed in the HMD 10 similarly to a smartphone and the like. In addition, applications operating on the OS are installed in the HMD 10. It should be noted that the same type of applications (for example, a web browser, a document creation application, and the like) are installed in the HMD 10 and the terminal 20.

Each of icons 41 to 46 illustrated in FIG. 4 is an icon related to various settings of the HMD 10 or an icon for launching an installed application.

In addition, a screen on which icons for settings and for application launching as illustrated in FIG. 4 are displayed is referred to as a home screen.

The HMD 10 includes a camera capable of capturing eyes (pupils and irises) of a user, and is configured to be capable of detecting gaze of the user (a wearer of the HMD 10). In addition, the HMD 10 includes a camera capable of capturing fingers and the like of the user, and is configured to be capable of detecting a gesture by fingers of the user.

A user can operate an OS and an application of the HMD 10 by using gaze and a gesture. In addition, the user can also operate the OS and the application of the HMD 10 by voice.

As described above, the user uses the terminal 20 while wearing the HMD 10. In such a case, the user may have a desire to share, on the HMD 10, content that an application installed in the terminal 20 displays on a screen (a screen of the terminal 20).

For example, the user may wish to access a web page by operating the terminal 20 and browse the web page on both the terminal 20 and the HMD 10.

It should be noted that a web page accessed by an Internet browser of the terminal 20 corresponds to the content described above.

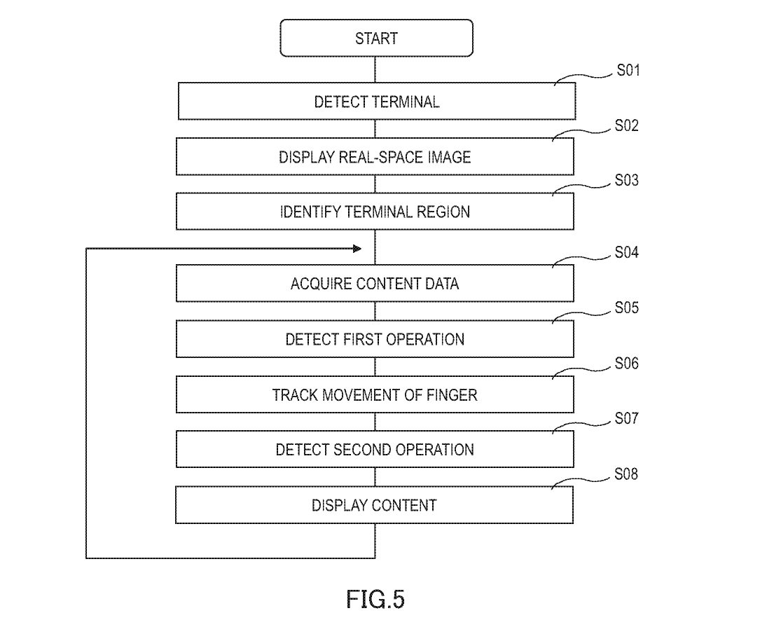

Hereinafter, operation (operation of the HMD 10) in a case where content displayed on a screen by the terminal 20 is shared on the HMD 10 will be described with reference to FIG. 5.

First, the user turns on power of the HMD 10. The user wears the activated HMD 10. The HMD 10 detects that the user has worn the HMD 10. In a case where the user wears the HMD 10, the HMD 10 authenticates the user.

In addition, the HMD 10 detects the terminal 20 (step S01). For example, the HMD 10 detects the terminal 20 that has been paired in advance by Bluetooth (registered trademark). The HMD 10 recognizes the terminal 20 existing in the real world.

The HMD 10 captures a real space and displays a real-space image on displays inside goggles (step S02).

The HMD 10 identifies a region in which the terminal 20 appears in the real-space image (identify a terminal region; step S03). For example, the HMD 10 grasps a position of the terminal 20 (coordinate information in the real-space image) by applying image recognition to the real-space image.

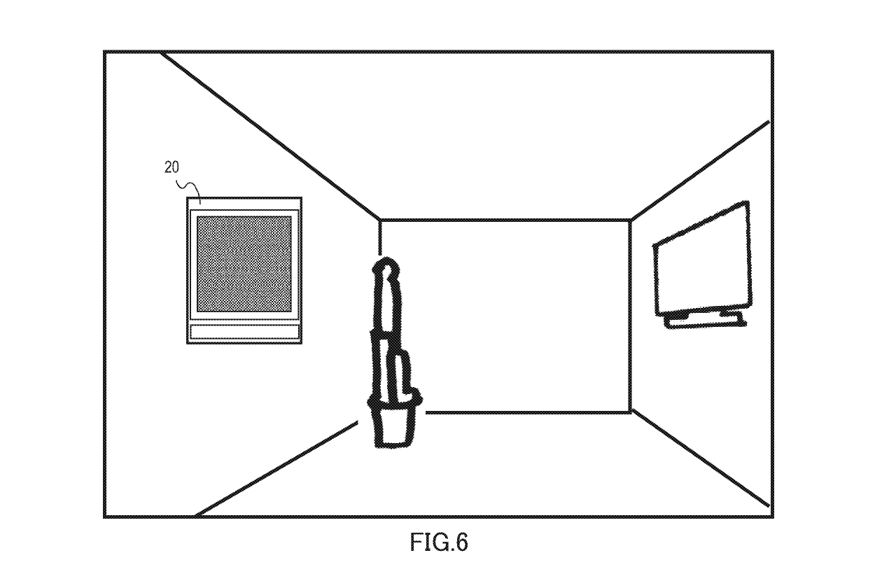

For example, the HMD 10 identifies a position of a region in which the terminal 20 illustrated in FIG. 6 appears. It should be noted that, in the following description, a region in which the terminal 20 appears in the real-space image is referred to as a "terminal region". In addition, in drawings including FIG. 6, description regarding a hand of a user holding the terminal 20 is omitted.

As described above, the terminal 20 opens predetermined content. In the example of FIG. 6, content (a screen corresponding to the content) opened by an application of the terminal 20 is displayed in a gray-colored region.

The HMD 10 acquires content data from the terminal 20 (step S04).

Content data is data corresponding to content displayed on a screen of the terminal 20. For example, in a case where the terminal 20 accesses a web page, hypertext constituting an entity of the web page corresponds to the content data.

The HMD 10 acquires the content data from the terminal 20 by wireless communication means such as Bluetooth (registered trademark). The HMD 10 stores the content data acquired from the terminal 20. In other words, the terminal 20 transmits the content data periodically or at a predetermined timing, and the HMD 10 stores the received content data.

The HMD 10 detects a predetermined operation by a user in the terminal region (detect a first operation; step S05). For example, the HMD 10 detects an operation in which the user pinches content displayed in the terminal region (an operation as if virtually pinching the content).

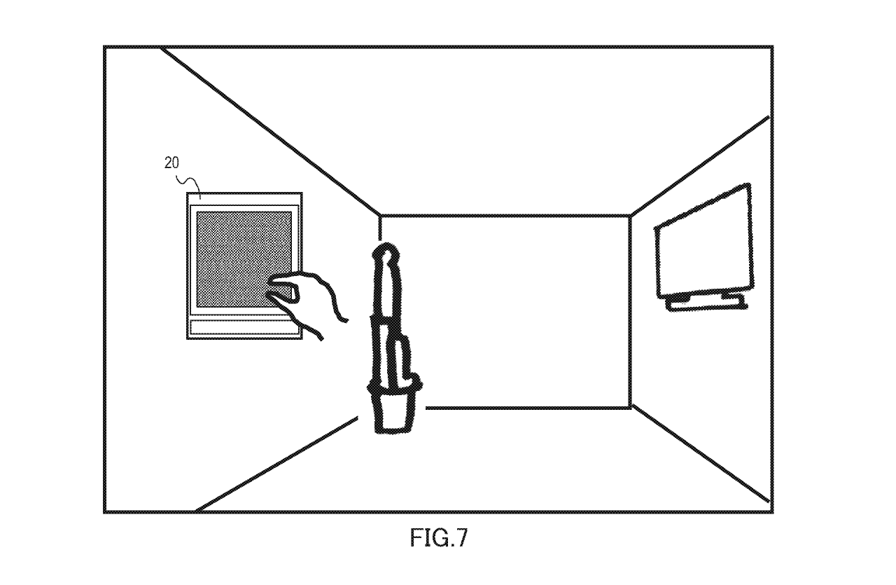

For example, the HMD 10 detects an operation by a finger of the user as illustrated in FIG. 7.

The HMD 10 displays, superimposed on the real-space image, content corresponding to content data acquired from the terminal 20 in response to a pinching operation by the user being detected. Specifically, the HMD 10 displays, on the real-space image, content corresponding to content data stored immediately before the pinching operation by the user is detected.

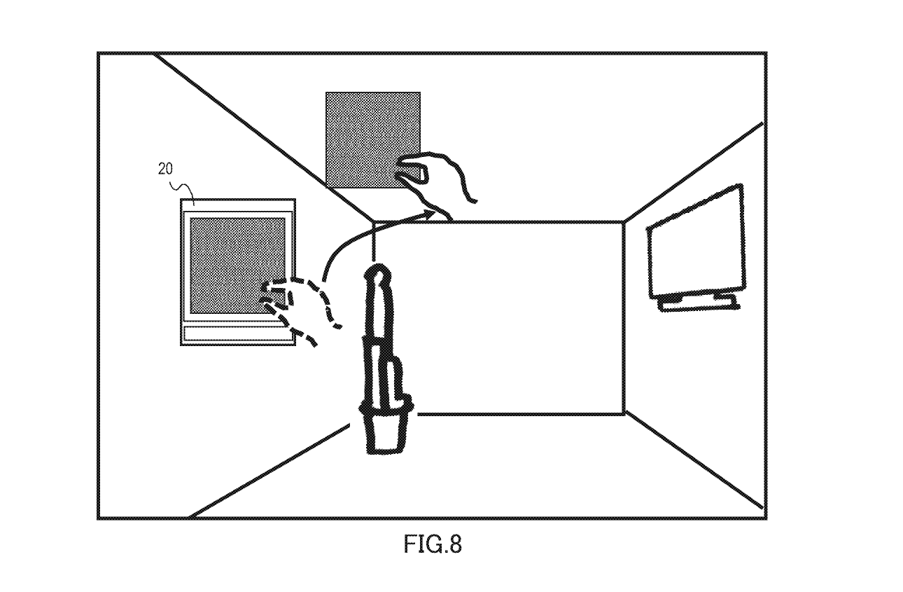

The HMD 10 tracks movement of fingers (hand) of the user who has performed the predetermined operation (the first operation) (step S06). Specifically, the user moves the fingers while pinching the content with the fingers (while maintaining a shape of the pinching fingers). The HMD 10 tracks movement of the fingers (see FIG. 8).

The user moves the fingers to a location other than the terminal region in the real-space image (moves the fingers pinching the object).

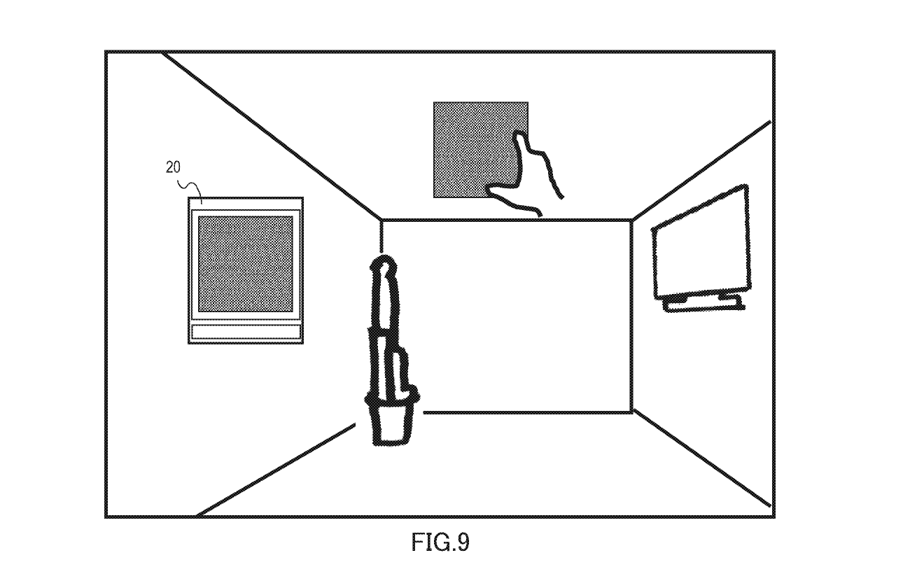

The HMD 10 detects a predetermined operation by the user at a movement destination of the fingers of the user (a location outside the terminal region at which movement of the fingers stops) (detect a second operation; step S07). For example, the HMD 10 detects an operation by the user as if releasing the pinched content (see FIG. 9).

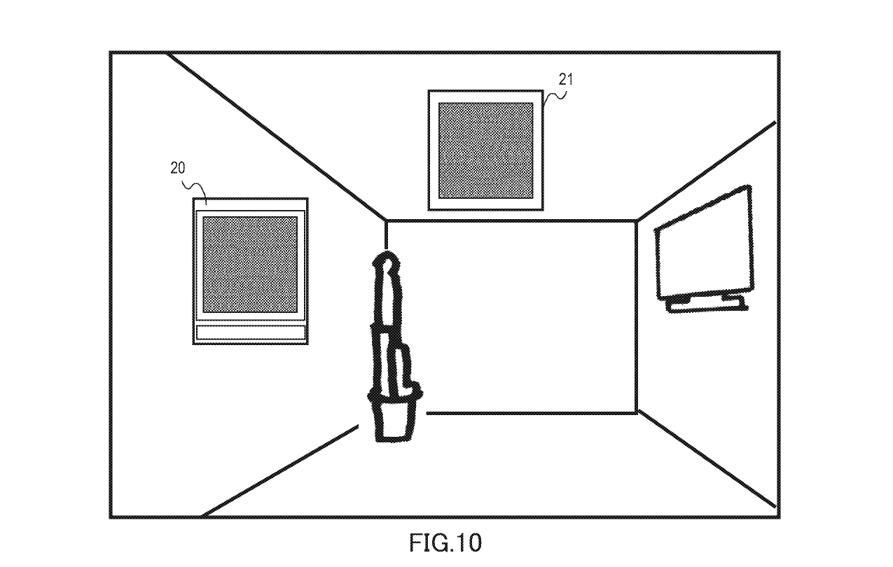

The HMD 10 displays the content at a location where the second operation is detected (step S08). Specifically, the HMD 10 sets a window 21 at a location where the user has released the content as illustrated in FIG. 10, and displays content data received from the terminal 20 in the set window 21.

The HMD 10 repeats processing of steps S04 to S08.

It should be noted that an operation by the user on the terminal 20 is reflected in content displayed in the window 21. Since the terminal 20 transmits the content data periodically or at a predetermined timing, the HMD 10 may update display of the window 21 by using the received content data.

Subsequently, details of the HMD 10 according to the first example embodiment will be described.

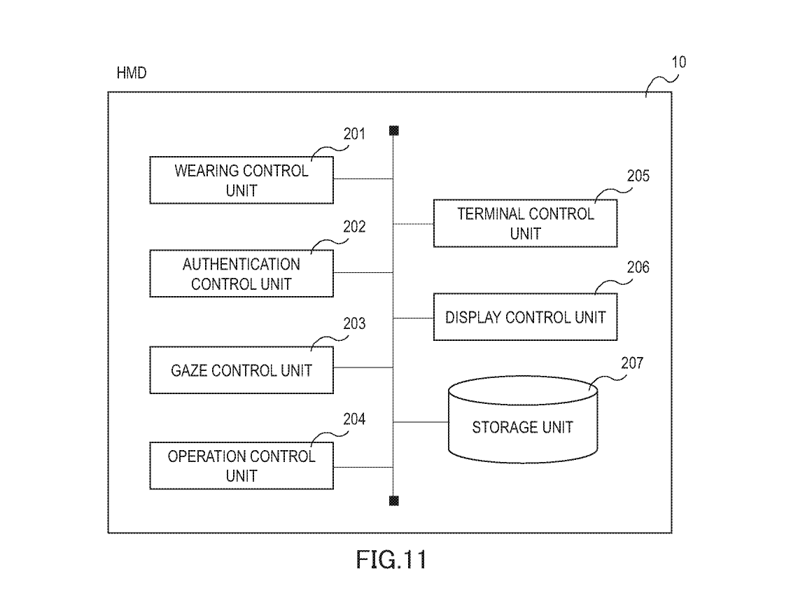

FIG. 11 is a diagram illustrating an example of a processing configuration (processing modules) of the HMD 10 according to an example embodiment of the present disclosure. The HMD 10 includes a wearing control unit 201, an authentication control unit 202, a gaze control unit 203, an operation control unit 204, a terminal control unit 205, a display control unit 206, and a storage unit 207, with reference to FIG. 11.

Each module illustrated in FIG. 11 is implemented by an OS or an application of the HMD 10.

The wearing control unit 201 is a control means for detecting that a user has worn the HMD 10 or that the user has removed the HMD 10. The wearing control unit 201 detects start of use and end of use of the HMD 10 by the user.

The wearing control unit 201 detects that the user has worn the HMD 10 based on image data obtained from a camera installed inside the HMD 10 and output signals obtained from sensors. Similarly, the wearing control unit 201 detects that the user has removed the HMD 10 based on image data obtained from the camera and the like.

In a case where the wearing control unit 201 detects that the user has worn the HMD 10, the wearing control unit 201 notifies other modules of that fact. Similarly, in a case where the wearing control unit 201 detects that the user has removed the HMD 10, the wearing control unit 201 notifies other modules of that fact.

The authentication control unit 202 is a means for authenticating a user who intends to use the HMD 10. The authentication control unit 202 includes a function as a biometric information acquisition means for acquiring biometric information of the user, and a function as an authentication means for authenticating the user based on the acquired biometric information.

For example, the authentication control unit 202 authenticates a user (a person to be authenticated) by using biometric information.

It should be noted that the biometric information includes, for example, data (feature value) calculated from physical characteristics unique to an individual such as a face, a fingerprint, a voiceprint, a vein, a retina, and an iris pattern of an eye. Alternatively, the biometric information may be image data such as a face image, a fingerprint image, and the like. The biometric information may be anything that includes physical characteristics of a user as information. In the example embodiment of the present disclosure, a case where an iris (an iris pattern) is used will be described.

The authentication control unit 202 acquires and stores an iris feature value (an iris pattern) of the user at a time of initial use by the user and the like. The authentication control unit 202 acquires and stores an iris feature value of one eye or both eyes.

In a case where the user uses the HMD 10 for a second time or later, the authentication control unit 202 authenticates the user by using the iris feature value acquired as described above. The authentication control unit 202 performs matching processing by using an iris feature value of the user (a person to be authenticated) and the stored iris feature value described above.

In a case where the two iris feature values are substantially identical, the authentication control unit 202 determines authentication success. In a case where the two iris feature values do not match, the authentication control unit 202 determines authentication failure.

In a case where authentication of the person to be authenticated succeeds, the authentication control unit 202 permits use of the HMD 10 by the user. In a case where authentication of the person to be authenticated fails, the authentication control unit 202 refuses use of the HMD 10 by the user. Alternatively, the authentication control unit 202 may treat a user for whom authentication fails as a "guest". The HMD 10 may limit functions to be provided to the guest.

It should be noted that existing technology can be used for calculation of an iris feature value and authentication processing using two iris feature values, and detailed description thereof will be omitted.

The gaze control unit 203 is a means for performing control related to gaze of the user. For example, the gaze control unit 203 tracks gaze of the user and identifies (estimates) a gaze direction of the user.

First, the gaze control unit 203 performs calibration for gaze tracking at a time of initial use of the HMD 10 by the user.

For example, the gaze control unit 203 displays an object for calibration on a screen and instructs the user to stare at the displayed object. The gaze control unit 203 stores a relationship between a position at which the object is displayed and a direction of an eye (a pupil) of the user. The gaze control unit 203 displays the object at various locations in a visual field of the user and stores a relationship between the object and a direction of the eye.

The gaze control unit 203 identifies a gaze direction by using a direction of an eye of the user acquired by calibration.

The gaze control unit 203 constantly detects (tracks) the gaze direction of the user during activation of the HMD 10 and notifies other modules of a detection result.

The operation control unit 204 is a means for performing control related to operation of the HMD 10 by the user.

For example, the operation control unit 204 detects an operation by the user based on image data obtained by capturing a hand and fingers of the user. For example, the operation control unit 204 detects an operation as if pinching an object with a thumb and an index finger, and an operation as if releasing the pinched object.

For example, the operation control unit 204 detects an operation (gesture) of the user by inputting image data to an AI (Artificial Intelligence) model prepared in advance.

The operation control unit 204 constantly detects an operation by fingers of the user (for example, a pinching operation and a releasing operation) during activation of the HMD 10. In a case where the operation control unit 204 determines that the user has performed a predetermined operation based on notification from the gaze control unit 203 and the detected operation, the operation control unit 204 notifies other modules of that fact.

For example, in a case where an icon is displayed on an extension line of gaze of the user and the user performs a pinching operation, the operation control unit 204 determines that the user has performed an operation related to the icon. For example, the operation control unit 204 notifies other modules of information related to operations such as "a setting menu has been activated" and "an application has been activated" (hereinafter referred to as operation information).

In addition, the operation control unit 204 also detects an operation of fingers appearing in the real-space image. For example, the operation control unit 204 analyzes the real-space image by using the AI model and detects an operation by fingers of the user.

For example, in a case where the user performs a predetermined operation at a location other than an augmented reality image (for example, an icon and a button) generated by the HMD 10 such as an icon, the operation control unit 204 identifies a type and a position of the operation.

For example, in a case where the user performs a pinching operation and a releasing operation at a location where an icon and the like does not appear, the operation control unit 204 notifies the display control unit 206 of a type of the operation and a position at which the operation is performed (coordinate information in a camera coordinate system) as operation information.

For example, the operation control unit 204 notifies the display control unit 206 of operation information such as "pinching operation; (X1, Y1)". Alternatively, the operation control unit 204 notifies the display control unit 206 of operation information such as "releasing operation; (X3, Y3)".

It should be noted that, in a case where the operation control unit 204 detects a pinching operation, the operation control unit 204 sets a location at which a thumb and an index finger contact as a location at which the pinching operation is performed, and calculates coordinate information thereof. In addition, in a case where the operation control unit 204 detects a releasing operation, the operation control unit 204 sets a location at a moment a thumb and an index finger separate as a location at which the releasing operation is performed, and calculates coordinate information thereof.

In a case where a position of the fingers changes without a change in an operation (a shape of the fingers) of the user, the operation control unit 204 notifies the display control unit 206 of operation information indicating that the operation by the user is continuing, together with the changed position of the fingers. For example, the operation control unit 204 notifies the display control unit 206 of operation information such as "operation continuation: (X2, Y2)".

In this manner, the operation control unit 204 includes a function as a detection means for detecting that the user has performed a first operation (for example, a pinching operation) on a region in which a predetermined terminal (the terminal 20) appears in the real-space image obtained by capturing the real space. In addition, the detection means detects that the user has performed a second operation (for example, a releasing operation) at a predetermined location in the real-space image.

The terminal control unit 205 is a means for performing control related to the terminal 20. The terminal control unit 205 includes a function as an acquisition means for acquiring content data corresponding to content displayed on a screen of a predetermined terminal (the terminal 20).

The terminal control unit 205 communicates with the terminal 20 by using wireless communication means such as Bluetooth (registered trademark) and Wi-Fi (Wireless Fidelity). The terminal control unit 205 notifies the display control unit 206 of that fact in a case where communication with the terminal 20 becomes possible.

In addition, the terminal control unit 205 acquires content data from the terminal 20. The terminal control unit 205 delivers the acquired content data to the display control unit 206.

The display control unit 206 is a display means for performing control related to display of the HMD 10. The display control unit 206 includes a function as a recognition means for recognizing a predetermined terminal (the terminal 20) existing in a real space. The recognition means recognizes a region (a terminal region) in which the terminal 20 appears in the real-space image by image recognition.

The display control unit 206 displays, on the displays inside goggles, an image (a real-space image) obtained by capturing a real world by the video see-through method described above, and displays an object (an augmented reality image) such as an icon and a button superimposed on the image. The display control unit 206 repeats the operation during activation of the HMD 10.

In a case where the HMD 10 and the terminal 20 are in a communicable state, the display control unit 206 detects the terminal region (a region in which the terminal 20 appears) in the real-space image.

Specifically, the display control unit 206 determines whether a terminal region is present by applying template matching to the real-space image obtained from the video camera. Alternatively, the display control unit 206 may determine whether the terminal region is present by using a learning model prepared in advance.

In a case where the terminal region is detected, the display control unit 206 identifies a position of the detected terminal region. Specifically, the display control unit 206 sets a mounted position of the video camera as an origin of a camera coordinate system and calculates coordinates of the terminal 20 in the real-space image obtained from the video camera. More specifically, the display control unit 206 calculates coordinates of four corners of the region in which the terminal 20 appears in the camera coordinate system and identifies the four corners (four points) as a position of the terminal region.

As described above, the display control unit 206 acquires operation information from the operation control unit 204.

In a case where operation information related to a pinching operation with coordinate information (for example, "pinching operation; (X1, Y1)") is acquired, the display control unit 206 determines whether the pinching operation has been performed within the terminal region. For example, the display control unit 206 determines whether an operation as illustrated in FIG. 7 has been performed.

In a case where the pinching operation is performed outside the terminal region, the display control unit 206 performs no particular operation.

In a case where the pinching operation is performed within the terminal region, the display control unit 206 determines that the user has started an operation related to sharing content of the terminal 20.

In response to the first operation (the pinching operation) being detected, the display control unit 206 displays content (for example, a web page) corresponding to content data acquired by the terminal control unit 205, superimposed on the real-space image.

For example, the display control unit 206 delivers the content data to an application capable of handling the content data and acquires image data from the application. For example, the display control unit 206 delivers hypertext of a web page to a web browser and acquires image data from the web browser. The display control unit 206 displays content (for example, a web page corresponding to hypertext) corresponding to content data acquired immediately before the pinching operation by the user is detected, at a location in the real-space image where the pinching operation is detected.

Thereafter, in a case where operation information related to operation continuation (for example, "operation continuation; (X2, Y2)") is acquired, the display control unit 206 displays content corresponding to content data acquired from the terminal control unit 205 at the coordinate position.

Specifically, the display control unit 206 displays the content so as to follow movement of fingers (hand) of the user as illustrated in FIG. 8. That is, in a case where the user maintains the first operation (the pinching operation), the display control unit 206 displays the content corresponding to the acquired content data so as to follow the fingers of the user displayed in the real-space image.

It should be noted that the content displayed while following movement of the fingers of the user may be content corresponding to content data acquired immediately before the pinching operation, or may be content corresponding to content data acquired immediately before operation information indicating operation continuation is received. The display control unit 206 may fix the content displayed together with the fingers of the user to the content immediately before the pinching operation, or may display content updated in accordance with content data received from the terminal 20.

Thereafter, the display control unit 206 acquires, from the operation control unit 204, operation information related to a releasing operation with coordinate information (for example, "releasing operation; (X3, Y3)") (see FIG. 9).

In this case, the display control unit 206 sets the window 21 at a location where the releasing operation is performed as illustrated in FIG. 10 and displays the content data acquired from the terminal control unit 205 in the window 21.

In this manner, in a case where the user moves the fingers to a location at which an augmented reality image is not displayed while maintaining the first operation, the display control unit 206 displays the content corresponding to the content data superimposed on the location in the real-space image at which the augmented reality image is not displayed. More specifically, the display control unit 206 displays content corresponding to the acquired content data superimposed on the real-space image at a location where the second operation is detected.

That is, in a case where the user moves the fingers while keeping the pinching operation and performs the releasing operation in a region in which an icon and the like is not displayed, the display control unit 206 displays (shares) content displayed on the terminal 20 at a location where the releasing operation is performed.

It should be noted that, in a case where the user moves the fingers while keeping the pinching operation and performs the releasing operation in a region in which an icon and the like is displayed, the display control unit 206 may not display the content, or may display the content by setting the window 21 near the icon and the like.

The storage unit 207 is a means for storing information necessary for operation of the HMD 10.

Next, variations according to the first example embodiment will be described.

### Variation 1

In the above example embodiment, configuration, operation, and the like of the HMD 10 have been described assuming a case where content (content data) acquired from the terminal 20 is content appearing on an entire screen of the terminal 20. In particular, this is because a smartphone basically displays an image output by a single application on an entire screen.

However, in a case where the terminal 20 is a notebook computer and the like, the HMD 10 may acquire, among a plurality of content items displayed on the screen, content on which the user has performed the pinching operation. For example, in a case where the user performs the pinching operation in a right-side region of a screen of the notebook computer, the terminal control unit 205 may instruct the terminal 20 to transmit content data of content displayed on the right side.

### Variation 2

The HMD 10 and the terminal 20 may transmit and receive the content data by using a server on a cloud instead of directly transmitting and receiving the content data by using wireless communication means such as Bluetooth (registered trademark).

In this case, the user logs into the HMD 10 and the terminal 20 by using the same ID. The HMD 10 and the terminal 20 logged in with the same ID access the same online storage on the cloud. The terminal 20 registers content data of content being opened in the online storage. The HMD 10 acquires the registered content data.

The HMD 10 may display content superimposed on the real-space image by using the acquired content data.

### Variation 3

The display control unit 206 (recognition means) may acquire position information of the terminal 20 and recognize the terminal 20 existing in the real space by using the acquired position information.

More specifically, the terminal control unit 205 acquires the position information of the terminal 20 by instructing the terminal 20 to transmit position information (latitude and longitude). In addition, the terminal control unit 205 calculates position information of the HMD 10.

The terminal control unit 205 notifies the display control unit 206 of the position information of the terminal 20 and the position information of the HMD 10. In a case where the two pieces of position information are substantially the same, the display control unit 206 determines that the terminal 20 exists near the HMD 10.

The display control unit 206 may recognize the terminal 20 by using the position information supplementarily in consideration of a case where it is difficult to accurately recognize the terminal 20 only by image identification processing. For example, in a case where the display control unit 206 grasps that the terminal 20 exists near the HMD 10 based on the position information, the display control unit 206 may detect the terminal region in the real-space image.

### Variation 4

The operation control unit 204 of the HMD 10 may calculate a distance between a camera for capturing the real-space image and fingers of the user. In addition, the display control unit 206 may determine a size of the window 21 for displaying the content corresponding to the acquired content data based on the calculated distance.

For example, the operation control unit 204 estimates a distance from the camera (the HMD 10) to the fingers of the user based on a size of the fingers appearing in the real-space image. Alternatively, the operation control unit 204 may estimate the distance from the camera to the fingers by inputting, to a learning model obtained by machine learning, an image in which the fingers appears. The operation control unit 204 notifies the display control unit 206 of the estimated distance.

The display control unit 206 determines a size of the window 21 for displaying the content based on the notified distance.

For example, the display control unit 206 arranges the window 21 to be larger as a distance between the camera (the HMD 10) and the fingers is longer.

In a case where the content is placed farther away, the display control unit 206 determines that the user has difficulty visually recognizing the content if a small window 21 is prepared, and prepares a large window 21. In contrast, in a case where the content is placed closer, the display control unit 206 determines that the user has difficulty visually recognizing other content if the large window 21 is prepared, and prepares the small window 21.

### Variation 5

The operation control unit 204 of the HMD 10 may acquire an operation by the user on content displayed superimposed on the real-space image based on an operation by fingers of the user or gaze of the user, and may notify the terminal 20 of the acquired operation by the user. That is, the operation control unit 204 may notify the terminal 20 of an operation by the user on content being opened by the terminal 20 displayed on the HMD 10. The HMD 10 may reflect the operation by the user on the terminal 20 (a screen of the terminal 20 and content being opened by the terminal 20) by notifying the terminal 20 of the operation.

In this case, the operation control unit 204 detects an operation on content displayed in the window 21 based on at least one of movement of fingers of the user and movement of gaze. For example, the operation control unit 204 detects a pinching operation and a releasing operation performed while the user stares at a web page displayed in the window 21.

The operation control unit 204 notifies the terminal control unit 205 of the detected operation. The terminal control unit 205 transmits, to the terminal 20, a command corresponding to the notified operation. For example, in a case where the "pinching operation" is notified, the terminal control unit 205 notifies the terminal 20 of a page-forward command. Alternatively, in a case where the "releasing operation" is notified, the terminal control unit 205 notifies the terminal 20 of a page-back command.

The terminal 20 controls the content by the notified command. As a result, content of the window 21 set in the real-space image of the HMD 10 is updated.

In this manner, in a case where the user operates the content displayed on the HMD 10, content of the terminal 20 operates in conjunction.

As described above, the HMD 10 according to the first example embodiment detects an operation by a user on the terminal 20 such as a smartphone appearing on a screen (a real-space image). For example, the HMD 10 detects a pinching operation by fingers of the user superimposed on the terminal region in which the terminal 20 appears in the real-space image. Thereafter, the HMD 10 tracks movement of the fingers of the user and detects an operation by the user at a movement destination of the fingers. For example, the HMD 10 detects an operation as if releasing the pinched content (a screen and content appearing on the terminal 20 such as a smartphone) by the user. The HMD 10 displays content corresponding to content data acquired from the terminal 20 at a location where the releasing operation is detected. In this manner, the user can display the same content as the terminal 20 at any location in the real-space image at which an icon and the like is not displayed. As a result, convenience for a user who desires screen sharing and content sharing with the terminal 20 such as a smartphone is improved.

In this manner, during use of the HMD 10, the user can view content displayed on the terminal 20 such as a smartphone on a screen of the HMD 10 by an intuitive operation. For a user wearing the HMD 10, a screen of a smartphone and the like used simultaneously is often difficult to view. However, the user of the HMD 10 can move content displayed on the terminal 20 such as a smartphone to an augmented reality space that is easy to view.

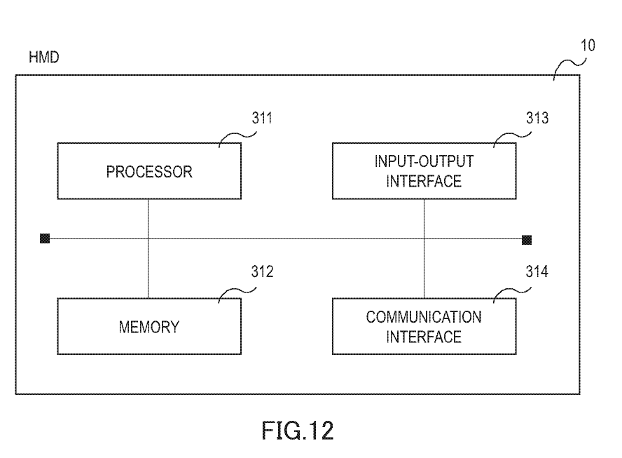

Next, a hardware configuration of an individual apparatus that constitutes the information processing system will be described. FIG. 12 is a diagram illustrating an example of a hardware configuration of the HMD 10.

The HMD 10 can be configured by an information processing apparatus (a so-called computer) and has a configuration illustrated as an example in FIG. 12. For example, the HMD 10 includes a processor 311, a memory 312, an input-output interface 313, a communication interface 314, and the like. The components such as the processor 311 described above are connected via an internal bus and the like and are configured to be capable of communicating with each other.

However, the configuration illustrated in FIG. 12 is not intended to limit a hardware configuration of the HMD 10. The HMD 10 may include hardware not illustrated in the figure, and may omit the input-output interface 313 as needed. In addition, the number of components such as the processor 311 included in the HMD 10 is not intended to be limited to the example of FIG. 12, and for example, a plurality of processors 311 may be included in the HMD 10.

For example, the processor 311 is a programmable device such as a CPU (Central Processing Unit), an MPU (Micro Processing Unit), a DSP (Digital Signal Processor), and the like. Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and the like. The memory 312 stores an OS program, an application program, and various kinds of data.

The input-output interface 313 is an interface for a display apparatus and an input apparatus not illustrated. The display apparatus is, for example, a liquid crystal display or the like. The input apparatus is, for example, an apparatus that receives a user operation such as a keyboard and a mouse and the like.

The communication interface 314 is a circuit, a module, and the like for performing communication with other apparatuses. For example, the communication interface 314 includes a NIC (Network Interface Card) and the like.

The functions of the HMD 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

The HMD 10, which is an information processing apparatus, is equipped with a computer, and the functions of the HMD 10 can be realized by causing the computer to execute a program. In addition, the HMD 10 executes a control method of the HMD 10 by using the program.

### Variations

It should be noted that the configurations, operations, and the like of the information processing system according to the above example embodiment are examples and are not intended to limit configuration and the like of the system.

In the above example embodiment, description has been made by taking, as an example, the HMD 10 adopting a video see-through method. However, the HMD 10 may perform screen display by adopting an optical see-through method.

The display control unit 206 may display, in a reduced manner, content moving together with fingers of the user. By displaying small content, the display control unit 206 may facilitate determination, by the user, of a location at which the user wants to place the content (a location at which the window 21 is to be set).

During movement of fingers of the user (fingers pinching the content), the display control unit 206 may display an illustration or an icon instead of an image of the content itself.

While the content is being moved, the display control unit 206 may hide content in the terminal region.

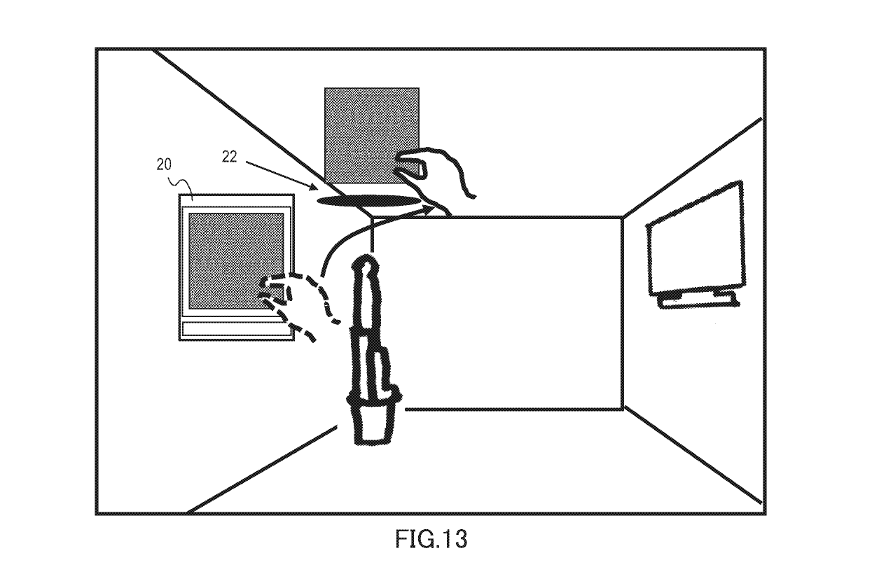

The display control unit 206 may display a shadow 22 under the content being moved (see FIG. 13).

In the above example embodiment, description has been made regarding a case where the HMD 10 acquires content data from the terminal 20 and superimposes content corresponding to the content data on the real-space image. However, the HMD 10 may acquire image data of an image displayed on the terminal 20 and superimpose the acquired image data on the real-space image.

The first operation described in the above example embodiment is not limited to the pinching operation. For example, the first operation may be an operation of clenching a hand, an operation of holding a palm over the terminal 20, and the like. In a case where the first operation is the pinching operation, for example, the HMD 10 may recognize a finger operation of pinch-in on a screen of a smartphone (the terminal 20) as the first operation (the pinching operation). That is, there is a possibility that content displayed on the terminal 20 moves to the real-space image against an intention of the user. By differentiating an operation that can be performed by the user in operating the terminal 20 from the first operation, a decrease in usability can be suppressed. In addition, the second operation may also be changed according to a mode of the first operation and is not limited to the releasing operation.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to a head-mounted display and the like that seamlessly realize integration of a real world and virtual digital content.

A part or the entirety of the example embodiments described above may be described as in the following supplementary notes, but is not limited to the followings.

### Supplementary Note 1

An information processing apparatus including:
a recognition means that recognizes a predetermined terminal;
an acquisition means that acquires content data corresponding to content displayed on a screen of the predetermined terminal;
a detection means that detects that a user has performed a first operation on a region in which the predetermined terminal appears in a real-space image obtained by capturing a real space; and
a display means that displays, superimposed on the real-space image, the content corresponding to the acquired content data in response to the first operation being detected.

### Supplementary Note 2

The information processing apparatus according to supplementary note 1, wherein the display means displays, in a case where the user moves fingers to a location at which an augmented reality image is not displayed while maintaining the first operation, the content corresponding to the acquired content data superimposed on the location in the real-space image at which the augmented reality image is not displayed.

### Supplementary Note 3

The information processing apparatus according to supplementary note 2, wherein the display means displays, in a case where the user maintains the first operation, the content corresponding to the acquired content data so as to follow the fingers of the user displayed in the real-space image.

### Supplementary Note 4

The information processing apparatus according to supplementary note 2 or 3, wherein the detection means that detects that the user has performed a second operation at a predetermined location in the real-space image, and

wherein the display means displays the content corresponding to the acquired content data superimposed on the real-space image at the location where the second operation is detected.

### Supplementary Note 5

The information processing apparatus according to supplementary note 1, wherein the recognition means recognizes a region in which the terminal appears in the real-space image by image recognition.

### Supplementary Note 6

The information processing apparatus according to supplementary note 1, wherein the recognition means acquires position information of the predetermined terminal, and recognizes the terminal by using the acquired position information.

### Supplementary Note 7

The information processing apparatus according to supplementary note 1, wherein the detection means calculates a distance between a camera for capturing the real-space image and the fingers of the user, and

wherein the display means determines a size of a window for displaying the content corresponding to the acquired content data based on the calculated distance.

### Supplementary Note 8

The information processing apparatus according to supplementary note 1, further including an operation means that acquires an operation by the user on the content displayed superimposed on the real-space image based on an operation by fingers of the user or gaze of the user, and notifies the terminal of the acquired operation by the user.

### Supplementary Note 9

A control method of an information processing apparatus, the control method including:
a recognition step that recognizes a predetermined terminal;
a acquisition step that acquires content data corresponding to content displayed on a screen of the predetermined terminal;
a detection step that detects that a user has performed a first operation on a region in which the predetermined terminal appears in a real-space image obtained by capturing a real space; and
a display step that displays, superimposed on the real-space image, the content corresponding to the acquired content data in response to the first operation being detected.

### Supplementary Note 10

The control method of the information processing apparatus according to supplementary note 9, wherein the display step displays, in a case where the user moves fingers to a location at which an augmented reality image is not displayed while maintaining the first operation, the content corresponding to the acquired content data superimposed on the location in the real-space image at which the augmented reality image is not displayed.

### Supplementary Note 11

The control method of the information processing apparatus according to supplementary note 10, wherein the display step displays, in a case where the user maintains the first operation, the content corresponding to the acquired content data so as to follow the fingers of the user displayed in the real-space image.

### Supplementary Note 12

The control method of the information processing apparatus according to supplementary note 10 or 11, wherein the detection step that detects that the user has performed a second operation at a predetermined location in the real-space image, and wherein the display step displays the content corresponding to the acquired content data superimposed on the real-space image at the location where the second operation is detected.

### Supplementary Note 13

The control method of the information processing apparatus according to supplementary note 9, wherein the recognition step recognizes a region in which the terminal appears in the real-space image by image recognition.

### Supplementary Note 14

The control method of the information processing apparatus according to supplementary note 9, wherein the recognition step acquires position information of the predetermined terminal, and recognizes the terminal by using the acquired position information.

### Supplementary Note 15

The control method of the information processing apparatus according to supplementary note 9, wherein the detection step calculates a distance between a camera for capturing the real-space image and the fingers of the user, and

wherein the display step determines a size of a window for displaying the content corresponding to the acquired content data based on the calculated distance.

### Supplementary Note 16

The control method of the information processing apparatus according to supplementary note 9, further including an operation step that acquires an operation by the user on the content displayed superimposed on the real-space image based on an operation by fingers of the user or gaze of the user, and notifies the terminal of the acquired operation by the user.

### Supplementary note 17

A program causing a computer mounted on an information processing apparatus to perform processing for:
a recognition processing that recognizes a predetermined terminal;
a acquisition processing that acquires content data corresponding to content displayed on a screen of the predetermined terminal;
a detection processing that detects that a user has performed a first operation on a region in which the predetermined terminal appears in a real-space image obtained by capturing a real space; and
a display processing that displays, superimposed on the real-space image, the content corresponding to the acquired content data in response to the first operation being detected.

### Supplementary Note 18

The program according to supplementary note 17, wherein the display processing displays, in a case where the user moves fingers to a location at which an augmented reality image is not displayed while maintaining the first operation, the content corresponding to the acquired content data superimposed on the location in the real-space image at which the augmented reality image is not displayed.

### Supplementary Note 19

The program according to supplementary note 18, wherein the display processing displays, in a case where the user maintains the first operation, the content corresponding to the acquired content data so as to follow the fingers of the user displayed in the real-space image.

### Supplementary Note 20

The program according to supplementary note 18 or 19, wherein the detection processing that detects that the user has performed a second operation at a predetermined location in the real-space image, and

wherein the display processing displays the content corresponding to the acquired content data superimposed on the real-space image at the location where the second operation is detected.

### Supplementary Note 21

The program according to supplementary note 17, wherein the recognition processing recognizes a region in which the terminal appears in the real-space image by image recognition.

### Supplementary Note 22

The program according to supplementary note 17, wherein the recognition processing acquires position information of the predetermined terminal, and recognizes the terminal by using the acquired position information.

### Supplementary Note 23

The program according to supplementary note 17, wherein the detection processing calculates a distance between a camera for capturing the real-space image and the fingers of the user, and

wherein the display processing determines a size of a window for displaying the content corresponding to the acquired content data based on the calculated distance.

### Supplementary Note 24

The program according to supplementary note 17, further performing an operation processing that acquires an operation by the user on the content displayed superimposed on the real-space image based on an operation by fingers of the user or gaze of the user, and notifies the terminal of the acquired operation by the user.

In addition, a part or all of the configurations described in supplementary notes 2 to 8, which are dependent on supplementary note 1 as described above, may also be dependent on supplementary notes 9 and 17 in the same dependent relationship as supplementary notes 2 to 8. Furthermore, not limited to supplementary note 1 and supplementary notes 9 and 17, within a range not departing from the above-described example embodiments, a part or all of the configurations described as supplementary notes can likewise be made dependent on various hardware, software, various recording means for recording the software, or systems.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and spirit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An information processing apparatus comprising:
at least one memory storing a set of instructions; and
at least one processor configured to execute the set of instructions to:
recognize a predetermined terminal;
acquire content data corresponding to content displayed on a screen of the predetermined terminal;
detect that a user has performed a first operation on a region in which the predetermined terminal appears in a real-space image obtained by capturing a real space; and
display, superimposed on the real-space image, the content corresponding to the acquired content data in response to the first operation being detected.

2. The information processing apparatus according to claim 1, wherein
the at least one processor is further configured to execute the set of instructions to display, in a case where the user moves fingers to a location at which an augmented reality image is not displayed while maintaining the first operation, the content corresponding to the acquired content data superimposed on the location in the real-space image at which the augmented reality image is not displayed.

3. The information processing apparatus according to claim 2, wherein
the at least one processor is further configured to execute the set of instructions to display, in a case where the user maintains the first operation, the content corresponding to the acquired content data so as to follow the fingers of the user displayed in the real-space image.

4. The information processing apparatus according to claim 2, wherein
the at least one processor is further configured to execute the set of instructions to:
detect that the user has performed a second operation at a predetermined location in the real-space image; and
display the content corresponding to the acquired content data superimposed on the real-space image at the location where the second operation is detected.

5. The information processing apparatus according to claim 3, wherein
the at least one processor is further configured to execute the set of instructions to:
detect that the user has performed a second operation at a predetermined location in the real-space image; and
display the content corresponding to the acquired content data superimposed on the real-space image at the location where the second operation is detected.

6. The information processing apparatus according to claim 1, wherein
the at least one processor is further configured to execute the set of instructions to recognize a region in which the terminal appears in the real-space image by image recognition.

7. The information processing apparatus according to claim 1, wherein
the at least one processor is further configured to execute the set of instructions to:
acquire position information of the predetermined terminal; and recognize the terminal by using the acquired position information.

8. The information processing apparatus according to claim 1, wherein
the at least one processor is further configured to execute the set of instructions to:
calculate a distance between a camera for capturing the real-space image and the fingers of the user; and
determine a size of a window for displaying the content corresponding to the acquired content data based on the calculated distance.

9. The information processing apparatus according to claim 1, wherein
the at least one processor is further configured to execute the set of instructions to:
acquire an operation by the user on the content displayed superimposed on the real-space image based on an operation by fingers of the user or gaze of the user; and
notify the terminal of the acquired operation by the user.

10. A control method of an information processing apparatus, the control method comprising:
recognizing a predetermined terminal;
acquiring content data corresponding to content displayed on a screen of the predetermined terminal;
detecting that a user has performed a first operation on a region in which the predetermined terminal appears in a real-space image obtained by capturing a real space; and
displaying, superimposed on the real-space image, the content corresponding to the acquired content data in response to the first operation being detected.

11. A non-transitory computer-readable storage medium storing a program causing a computer mounted on an information processing apparatus to perform processing for:
recognizing a predetermined terminal;
acquiring content data corresponding to content displayed on a screen of the predetermined terminal;
detecting that a user has performed a first operation on a region in which the predetermined terminal appears in a real-space image obtained by capturing a real space; and
displaying, superimposed on the real-space image, the content corresponding to the acquired content data in response to the first operation being detected.
